(19) United States
(12) Patent Application Publication
(10) Pub. No.: US 2009/0055435 A1
(43) Pub. Date: Feb. 26, 2009

(54) Analyzer, a system and a method for defining a preferred group of users

(76) Inventors: Kimmo Kiviluoto, Helsinki (FI); Jari Saramaki, Fi-Espoo (FI)

Correspondence Address: ARENT FOX LLP, 1050 CONNECTICUT AVENUE, N.W., SUITE 400, WASHINGTON, DC, 20036, US

(21) Appl. No.: 11/665,069

(22) PCT Filed: Sep. 21, 2005
(86) PCT No.: PCT/FI05/50322

§ 371 Date: Oct. 21, 2008

(30) Foreign Application Priority Data
Oct. 12, 2004 (FI) 20041323

(51) Int. Cl. G06F 17/30

(52) U.S. Cl. 707/104.1; 707/E17.002

(57) ABSTRACT

The present invention relates to an analyzer, a system, a method, and a computer-readable medium for defining a preferred group of users, wherein the group is defined in the following way. The analyzer receives data from a data network node, which may be e.g. a (plurality of) data-base(s). After receiving the data, there is determined a social network of the users and a set of parameters for each user. The set of parameters may comprise e.g. an innovator score, a repeat user score and a social influence score. After the above determination, there is determined the preferred group of users based on the social network and the set of parameters. The information (or indication) of the preferred group of users may be utilized in various marketing activities (e.g. product launch or churn management).

### TECHNICAL FIELD OF THE INVENTION

The present invention relates to an analyzer, a system and a method for defining a preferred group of users from user data. Information of the preferred group of users may be utilized in e.g. new product launches, marketing campaigns, churn management, and planning marketing.

### BACKGROUND OF THE INVENTION

Nowadays active users of fast developing products, e.g. computer software, want to know of any new versions of the software or updates thereto. They also want to know about the new features and advantages (when compared to older version) of those products before their releases. Also some of the users are also interested of the release dates of new version and other possible information they may receive of the new product. Another interest of certain group of people, where from they want to know new releases, is books and movies. In this case the persons may be interested of certain writer (or certain type of books) or filmmaker (or certain type of movies). These persons wish to receive information of any new release of that certain writer or filmmaker.

However, since interests of people varies a lot, nowadays there is no real solution in which marketing could be directed to people that are interested of a new product.

In one marketing solution, the target group to which a marketing message is sent is defined usually by the user's demographics and/or previous purchase patterns. One of the typical ways to define the target group of users is to select the most potential age and education level for a product. This way of selecting the target group of users to which marketing messages are sent is however inefficient, in a way that large group of messages is sent to different users without any response from the potential buyers. Therefore large group of unnecessary messages are sent through a network (e.g. Internet). In this connection the marketing message covers traditional mail, commercials (on TV or radio), e-mails, mobile messages, etc.

Another prior art solution that is used is to send e-mail messages to all possible e-mail addresses. This method is also called spamming. The recent studies have revealed that about half of the e-mails sent in communications networks are already spam messages. This method causes a lot of unnecessary traffic in the communications networks.

In addition to the above drawbacks of the traditional marketing efforts, also the sales and marketing costs are unnecessarily high since there is a plurality of messages sent to various persons who are not interested of the new product. Also one drawback of so called mass marketing is that persons who would be interested of a new product does not necessarily realize the interesting marketing messages from all the messages received.

### SUMMARY OF THE PRESENT INVENTION

It is an object of the present invention to overcome or at least mitigate the disadvantages of the prior art. The present invention provides an analyzer, a system and a method to define a preferred group of users.

On the basis of the preferred group of users it is possible to define a limited number of potential marketing targets to whom marketing information is sent.

Further, it is an object of the present invention to provide a solution to reduce the number of marketing messages that are sent over a communications network. When the number of marketing messages is reduced, the overall load of the communications network also reduces. Also unnecessary messages are reduced, which also reduces the overall costs that are needed for sales and marketing (of a new product).

It is further an object to provide a solution to define more efficiently the users that are interested of the new product.

According to a first aspect of the present invention there is provided an analyzer for defining a preferred group of users, the analyzer comprising:
means for receiving data from a network node;
means for determining a social network of the users based on the received data;
means for determining a set of parameters for each user; and
means for determining the preferred group of users based on said social network and said set of parameters.

According to a second aspect of the invention there is provided a system for defining a preferred group of users, the system comprising:
a plurality of users;
a network node connected to the plurality of users;
at least one database comprising data of the users; and
an analyzer connected to the network node, the analyzer being arranged to define the preferred group of users from the data obtained from said at least one database by determining a social network of the users and determining a set of parameters for each user, and to provide user information of the preferred group of users, which is determined based on said social network and said set of parameters, to the network node.

According to a third aspect of the present invention there is provided a method for defining a preferred group of users in an analyzer, the method comprising:
receiving user data from a database;
determining a social network of the users based on the received user data;
determining a set of parameters for each user; and
combining the social network and the set of parameters to define the preferred group of users.

According to a fourth aspect of the present invention there is provided a computer-readable medium having stored thereon instructions for defining a preferred group of users, the instructions when executed by a processor cause the processor to:
receive user data from a database;
determine a social network of the users based on the received user data;
determine a set of parameters for each user; and
combine the social network and the set of parameters to define the preferred group of users.

The dependent claims describe additional features of the embodiments of the present invention.

The present invention provides several advantages when compared to the prior art solutions. For example, the present invention provides means and method for directing the marketing messages to the users that are interested in (certain) new products. More over, the present invention provides a solution in which it is possible to reduce the amount of unnecessary messages (for example of a product that is not interesting to some group of users) that are sent to the users. This also reduces the overall costs that are needed for sales and marketing of a new product. The present invention further enables faster product launch with decreased amount of costs. The information of the preferred group of users may also (not only in product launches) be utilized for example in marketing campaigns, churn management and planning marketing. Further advantages of the present invention are described in detailed description of the embodiments of the present invention with reference to the drawings.

### BRIEF DESCRIPTION OF THE DRAWINGS

For a better understanding of the present invention and in order to show how the same may be carried into effect reference will now be made to the accompanying drawings, in which:

FIG. 1 shows an inventive system of the present invention.

FIG. 2 shows an example of the social network map of the users.

FIG. 3 shows a flow chart illustrating the process of the present invention.

### DETAILED DESCRIPTION OF CERTAIN EMBODIMENTS

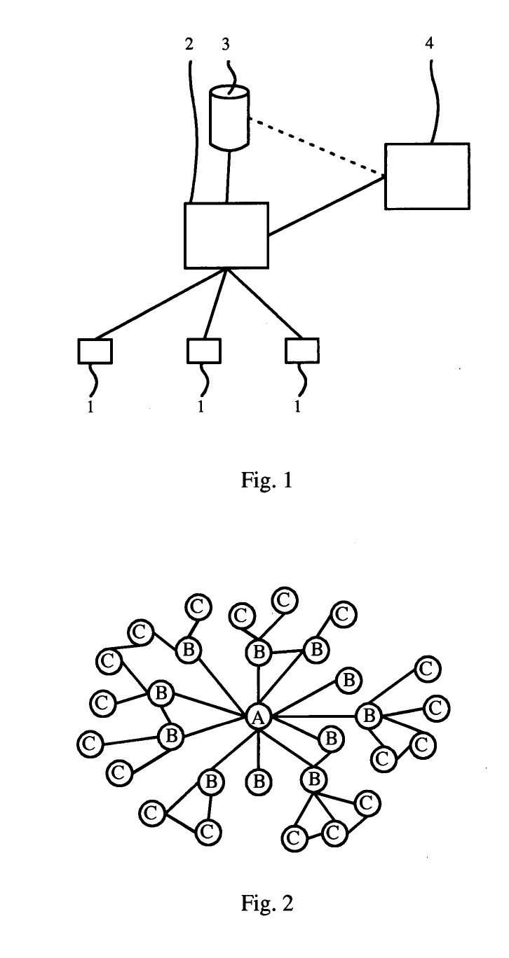

FIG. 1 shows an inventive system of the present invention. FIG. 1 shows users 1 of a service, a network node (or a service provider) 2, a database (or a server) 3 and an analyzer 4. The network node 2 in this connection may be for example a mobile telephone operator or an electronic store. The service may be e.g. call connection between two users 1 or selling e.g. books through the Internet. Even though the following presentation considers users (denoted as 1 in FIG. 1), the skilled person in the art realizes that the users of e.g. mobile communication system utilizes mobile terminals for connections to other users, i.e. a user uses his/her mobile terminal for utilizing a call (or sending a message) to another user.

In the inventive concept of the present invention, the network node 2 is connected to a database 3, which records the information of the users 1. The information may comprise communication data of the users 1, the earlier purchase history of the users 1, possible recommendation history of the users 1, and demographics of the users 1 (age, marital status, etc.). The communication data may include information of all type of contacts of the users 1, e.g. telephone calls, mobile messaging, e-mails, product recommendation messages, and instant messaging. The earlier purchase history may comprise e.g. what kinds of products the user 1 has purchased. The recommendation history may comprise information of what kind of products the user 1 has recommended to other users 1 (e.g. all purchased products and to whom the user 1 has recommended different products).

The analyzer 4 is connected to the network node 2. The analyzer may also be connected directly to the database 3. The network node 2 (and possibly also the database 3) may be connected directly or through a communications network (which is not shown in FIG. 1) to the analyzer 4.

In the inventive concept of the present invention, the network node 2 owner (or operator) wants to find out a preferred group of users (that may be called as alpha users) to more efficiently target the marketing resources so that the fastest possible product launch could be achieved. The alpha users are persons who are interested to buy new products, willing to recommend them to their friends, and have influence in his/her social network.

Through the network node 2 a request to define a preferred group of users (e.g. alpha users) is provided to the analyzer 4. At the same time the network node 2 may provide the analyzer 4 the data regarding the users 1 from the database 3. Alternatively, the analyzer 4 requests the data from the database 3 (directly or through the network node 2) after receiving the request to find the preferred group of users from the network node 2.

After receiving the data from the database 3, the analyzer 4 analyzes the information in the following way.

The analyzer 4 first analyzes the data to find out the contacts of the users 1 (e.g. which user has recommended a product to another user) to build a social network map between the users. An example of the users' social network map is shown in FIG. 2. The social network map may be built by means of a computer program comprising an algorithm for building the social network map, which computer program is implemented in the analyzer 4.

Thereafter the analyzer 4 will define most potential buyers or users by formulating an innovator score (which measures whether the subscriber was (or how likely the subscriber will be) the first adopter of the product in his local social network) from purchase and usage data provided from the server 3.

The analyzer 2 also defines a repeat user score from the previous product purchase history (which score measures whether the subscriber has taken (or how likely the subscriber will take) the product into routine use after first trial).

The analyzer 4 also defines a social network influence score (which measures the social influence of a given subscriber in the social subnetwork relevant to the product).

From the combination of the above scores the analyzer 4 defines an alpha user score (which score measures the net value of the subscriber in accelerating the product launch) for each user 1. The alpha user score may be defined e.g. such that each of the above scores are multiplied with a weighting value, and the weighted sum or weighted average defines the alpha user score.

The person skilled in the art appreciates that the order of the scoring steps above may be varied without departing from the scope of the invention. Also the steps may be processed essentially at the same time.

Further the process may be such that after defining each score, only certain number of users are selected, i.e. further scores are defined only to those users. This may be achieved e.g. with following two ways. In first alternative only those users that have gained higher score than certain predefined score are selected to the next phase (for example if the highest possible value for a score is 100, it may be defined that only those users that receive a score 70 or above are selected for next phase). In second alternative only a certain predefined number of users receiving the highest score are selected for next phase (for example if the predefined number of users is 500, then those users being within 500 highest score received users are the ones that are selected to the next phase).

After defining the alpha user scores for each user 1, the analyzer 4 will define the preferred group of users that were requested. Thereafter the analyzer 4 sends indication (or information) of the preferred group of users 1 to the network node 2. The indication sent to the network node 2 may be used to target more efficiently marketing messages to the users 1. This way the sent messages from the network node to different users may be reduced, and therefore also the overall loading of the network may be reduced. Finding alpha users also increases the efficiency of the product launch so that more possible users will know about the new product than by randomly picking up the users to which the marketing messages are sent (this will also decrease the costs needed for sales and marketing). In this connection the marketing message covers traditional mail, commercials (on TV or radio), e-mails, mobile messages, etc.

FIG. 2 shows a social network map that illustrates contacts between users to each other. This information may be defined on the basis of the call data records when the information is analyzed. In FIG. 2 there are denoted three different groups of users. The first group of users (only one of which is shown in FIG. 2) are denoted as A. The users of the first group (i.e. users A) are connected to the second group of users that are denoted as B. The second group of users may be user A's family, friends, coworkers, etc. However, the user A is directly connected to the second group of users (i.e. users B). Users B are further connected to a third group of users that are denoted as C in FIG. 2. As can be seen from FIG. 2, the user A has more contacts to others users than any other user. Therefore in word-of-mouth method, the user A would be the best target to start the marketing efforts.

In first embodiment of the present invention, a plurality of mobile telephone users 1 (three of which are shown in FIG. 1 to illustrate the present invention) are connected to a mobile telephone operator 2. The mobile telephone network and its functioning are known to the person skilled in the art, and therefore, they are not described more detailed herein. It is enough to mention that the mobile telephone network may be a traditional second or third generation mobile telephone network. Also what is send (in case of messages sent from one user to another) between the users (users' mobile terminals) is not relevant in this embodiment of the present invention.

The mobile telephone operator is connected to a database (or a server) 3, wherein the records of the communication data (i.e. data of calls and sent messages between users) is stored. The records may be call data records or alike, which indicates each user's 1 connections to other users 1. Even though the operator 2 and the database 3 are illustrated as separate (i.e. may be physically separated to different locations), the skilled person in the art realizes that they may be situated in the same location.

The operator 2 is further connected to an analyzer 4. Alternatively or in addition to the previous, the database (or server) 3 may be directly connected to the analyzer 4 as indicated by the dash line. The analyzer 4 may also be connected through a communications network (not shown in FIG. 1), e.g. the Internet, without departing from the scope of the present invention.

Since the operator 2 stores the communication data into the database 3, this information may be utilized to define the connections between the users 1. This communication data may be utilized to find out the users 1 that are so called alpha users. More over, the communication data may be utilized to define the preferred group of users.

In the first embodiment of the present invention, the operator 2 requests the analyzer 4 to define the preferred group of users so that the operator may market their new product with so few marketing messages to be sent to the users 1 as possible.

Thereafter the operator 2 may send the call data records to the analyzer 4 or the analyzer 4 may request the information from the operator 2 or the database 3.

After receiving the call data records from the database 3 (whether through the operator 2 or directly from the database 3), the analyzer 4 builds a social network from the communication data. From the social network the analyzer 4 defines a social network influence score, which measures the social influence of a given subscriber in the social subnetwork relevant to the product. From the subscribers' previous product purchase history, the analyzer 4 defines an innovator score, which measures whether the subscriber was (or how likely the subscriber will be) the first adopter of the product in his local social network. The analyzer will also define a repeat user score from the previous product purchase history, which score measures whether the subscriber has taken (or how likely the subscriber will take) the product into routine use after first trial. From the combination of the above scores the analyzer 4 will define an alpha user score for each user 1, which score measures the net value of the subscriber in accelerating the product launch. By evaluating the alpha user scores of the users 1 the analyzer 4 may define the most potential marketing targets, i.e. the preferred group of users.

Even though the first embodiment of the present invention considered mobile telephone environment, also traditional telephone environment may be applied to the above concept of the present invention without departing from the invention as defined in the appended claims.

In a second embodiment of the present invention a plurality of Internet users 1 are connected (e.g. by means of a computer connected to a communications network) to an Internet Service Provider (ISP) 2. The ISP 2 is connected to (or contains) a database (or a server) 3, which comprises traffic information between the users 1 of the Internet service. This information contains e.g. which user 1 has sent an e-mail message to another user (and also to whom) 1 or information of the parties of instant messaging. The ISP 2 is further connected to an analyzer 4. The analyzer 4 may further be connected directly to the database 3.

After a request (to define the preferred group of users) from the ISP 2 to the analyzer 4 is made, the process to define the preferred group of users follows the process as defined in the first embodiment of the present invention.

In a third embodiment of the present invention a plurality of electronic store users 1 are connected to an electronic store 2 in the Internet. There is further shown a database 3 connected to the store 2 and an analyzer 4, which is connected to the store 2 and possibly also directly to the database 3.

The database 3 comprises information of how different users 1 have recommended products of the store 2 to other users 1. The database further comprises e.g. users' 1 demographic information that may be utilized in marketing purposes.

The process according to this embodiment of the present invention includes the data gathering on all product purchases and recommendations to friends, and storing the information to the database 3.

When the electronic store 2 owners wish to launch a new product marketing campaign (or other marketing effort), it requests the analyzer 4 to define the preferred group of users from all users in the database 3. After receiving the request from the store 2, the analyzer 4 may request the data from the database 3 directly or through the processing equipment of the electronic store 2. Alternatively, the processing equipment of the electronic store 2 provides the information from the database 3 to the analyzer 4 when it sends the request.

When receiving the data from the database 3 in the analyzer 4, the analyzer 4 builds a social network (i.e. which user 1 has recommended a product to which ones of his/her friends) from the recommendations information. Thereafter, the analyzer 4 analyzes the purchase and usage data to find out the users 1 that are most potential buyers of the product (building innovator score). The analyzer 4 also differentiate regular customers of a new product from trial purchasers from the information received from the database 3 (building repeat user score). Then the analyzer 4 analyzes the information to define the most influential persons in the network (to build social influence score). The above steps are processed practically almost at the same time, even though they are described as chronological steps above. Also the order of performing the scoring phases may vary.

After receiving the above scores, the analyzer 4 forms an alpha user score (which is a combination of above scores) to define the preferred group of users.

When the preferred group of users is defined in the analyzer 4, the analyzer 4 will provide the indications of which users are within the preferred group of users to the processing equipment of the electronic store 2, which may utilize this information to target their marketing to certain users 1 of the service.

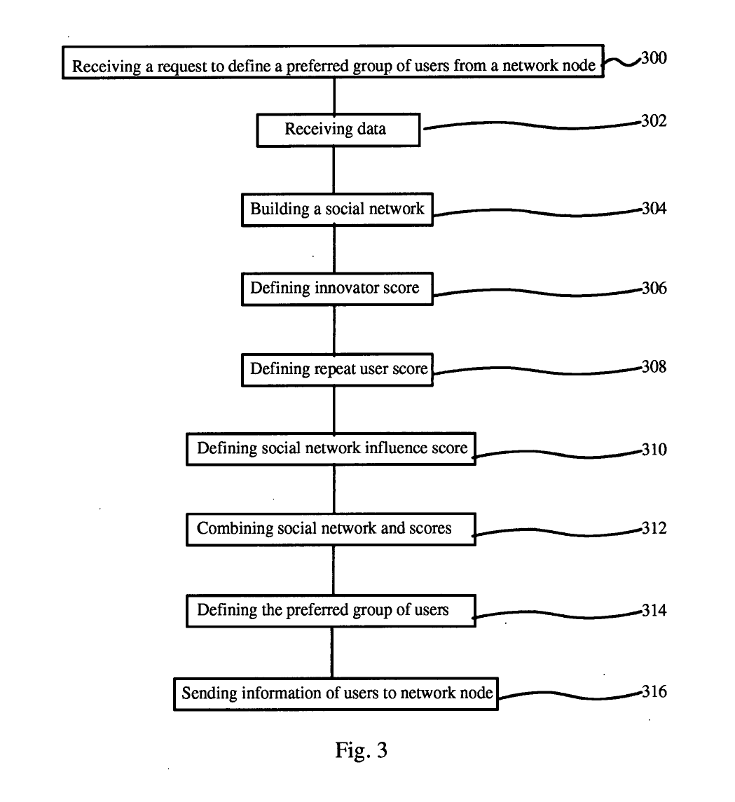

FIG. 3 shows a flow chart illustrating the process of the present invention.

The process starts, in step 300, with sending a request to define a preferred group of users (with respect to certain product) from a network node to an analyzer. At the same time the network node may also send an indication of how many users with highest possible score it wishes to receive (i.e. determine the number of users) and/or indication of lowest user score that it wishes to receive (i.e. the score value limit over which the users that are sent back to the network node must have). An example of the first of the above indications may be such that the network node may define that it wishes to receive indication of 500 best scoring users. An example for the latter indication may be such that when the total score is between 1 and 100, the network node wishes to receive indication of users scoring above 85.

After receiving the request, the analyzer will receive data, step 302, whether from a network node or directly from one or a plurality of databases. The data may be obtained in the following ways. The network node may send the data to the analyzer together with the request or after certain time period. The network node may also instruct a database (or several databases) to provide the data to the analyzer. The network node may provide together with the request e.g. IP address(es) of database(s), where from the analyzer may request the data. The database(s) may be physically located in or operationally connected to a network node. The different possibilities for network nodes have been already described with reference to the preferred embodiment of the present invention, and therefore, they are not repeated herein. Also the forms of the data correspond to the data that were identified with reference to the preferred embodiment of the present invention.

After receiving the data, the analyzer starts to define the preferred group of users as requested by the network node. First the analyzer builds a social network by utilizing the received data of contacts between the users, step 304. The social network may be built as a map (one type of which is illustrated in FIG. 2) illustrating the contacts between the users. Thereafter, the analyzer defines a set of parameters for each user. By properly weighting and calculating each parameter, the analyzer may form (or define) an innovator score, step 306, a repeat user score, step 308, and a social network influence score, step 310, for each user.

After the above steps are performed, the analyzer combines the social network and the set of parameters (or the above scores) into a one score, which may be called as alpha user score, in step 312. The alpha user score may be calculated on the basis of weighting different scores (or parameters) and whether to calculate a weighted score sum or weighted score average for each user.

On the basis of the combination, i.e. defining the alpha user score for each user, the analyzer may sort the users from highest to lowest score (or in any other way of sorting the data). On the basis of the alpha user score and the indications given by the network node, the analyzer defines the preferred group of users, step 314. The group may comprise a predetermined number of users or all users above certain predefined score limit (as described with reference to the preferred embodiment of the present invention).

After defining the preferred group of users, the analyzer sends information of the users in the preferred group of users to the network node, step 316. Where after the network node may utilize the received list of users by sending a message (or such information) of new product (or such) to the listed users.

Even though the above process is described as step after step basis, the skilled man in the art realizes that defining different scores may also be performed essentially at the same time (depending on the processing capacity of the analyzer).

Also after defining each score, it is possible to implement the method of selecting only a certain number of users to the next score defining phase as described in connection to the preferred embodiment of the invention.

Defining the preferred group of users may be implemented by a computer-readable medium having stored thereon instructions for defining a preferred group of users. When the instructions are executed by a processor, the instructions cause the processor to: receive user data from a database; determine a social network of the users based on the received user data; determine a set of parameters for each user; and combine the social network and the set of parameters to define the preferred group of users.

It will be appreciated by the skilled person in the art that various modifications may be made to the above-described embodiments without departing from the scope of the present invention, as disclosed in the appended claims. For example, the mobile network operator (as defined in the first embodiment of the present invention) may also act as an ISP (as defined in the second embodiment of the present invention). Further the analyzer may locate in operator's facilities or may be connected through a communications network.

1. An analyzer for defining a preferred group of users, characterized in, that the analyzer (4) comprises:
means for receiving data from a network node (2), wherein the data comprises users' recommendations to other users;
means for determining a social network of the users (1) based on the received data;
means for determining a set of parameters for each user (1), said set of parameters including a parameter for a social network influence score; and
means for determining the preferred group of users based on said social network and said set of parameters.

2. Analyzer according to claim 1, characterized in, that means for determining the preferred group of users is based on providing an alpha user score for each user (1).

3. Analyzer according to claim 2, characterized in, that the alpha user score is a combination of a social network and the set of parameters.

4. Analyzer according to claim 1, characterized in, that the set of parameters include an innovator score, and/or a repeat user score.

5. Analyzer according to claim 1, characterized in, that the analyzer (4) comprises a computer program comprising an algorithm to build a social network of the users (1).

6. Analyzer according to claim 1, characterized in, that the received data comprises communication data, which is data of contacts between users (1), and which comprises at least one of the following data: telephone calls, mobile messaging, e-mails, product recommendation messages, and instant messaging.

7. Analyzer according to claim 1, characterized in, that the received data is demographic data of the users (1).

8. Analyzer according to claim 1, characterized in, that the received data is earlier buying or usage data of the users (1).

9. Analyzer according to claim 2, characterized in, that the preferred group of users (1) is a group of users having alpha user score higher than a predefined alpha user score limit.

10. Analyzer according to claim 2, characterized in, that the preferred group of users is predefined number of users (1) having highest alpha user score.

11. A system for defining a preferred group of users, characterized in, that the system comprises:
a plurality of users (1);
a network node (2) connected to the plurality of users (1);
at least one database (3) comprising data of the users (1); and an analyzer (4) connected to the network node (2), the analyzer (9) being arranged to define the preferred group of users from the data obtained from said at least one database (3), wherein the data comprises users' recommendations to other users, by determining a social network of the users (1) and determining a set of parameters for each user (1), said set of parameters including a parameter for a social network influence score, and to provide user information of the preferred group of users, which is determined based on said social network and said set of parameters, to the network node (2).

12. A system according to claim 11, characterized in, that the data in said at least one database (3) comprises communication data, which is data of contacts between users (1), and which comprises at least one of the following data: telephone calls, mobile messaging, e-mails, product recommendation messages, and instant messaging.

13. A system according to claim 11, characterized in, that the data in said at least one database (3) comprises demographic data of the users (1).

14. A system according to claim 11, characterized in, that the data in said at least one database (3) comprises earlier buying or usage data of the users (1).

15. A system according to claim 11, characterized in, that the network node (2) and at least one database (3) are an integrated unit.

16. A system according to claim 11, characterized in, that the network node (2) and at least one database (3) are operationally connected to each other.

17. A system according to claim 11, characterized in, that the system comprises a plurality of databases (3), each database (3) comprising data of the users (1).

18. A system according to claim 11, characterized in, that the network node (2) is a telephone operator or a mobile network operator.

19. A system according to claim 11, characterized in, that the network node (2) is an Internet Service Provider (ISP).

20. A system according to claim 11, characterized in, that the network node (2) is an electronic store.

21. A system according to claim 11, characterized in, that the network node (2) comprises means for sending a message to the preferred group of users.

22. A system according to claim 21, characterized in, that the message is in the form of mobile messaging.

23. A system according to claim 21, characterized in, that the message is in the form of an e-mail.

24. A method for defining a preferred group of users in an analyzer, characterized in, that the method comprises:
receiving user data from a database (302), wherein the data comprises users' recommendations to other users;
determining a social network of the users based on the received user data (304);
determining a set of parameters for each user (1), said set of parameters including a parameter for a social network influence score; and combining the social network and the set of parameters (312) to define the preferred group of users (314).

25. A method according to claim 24, characterized in, that the method further comprises receiving a request to define the preferred group of users from a network node (300).

26. A method according to claim 24, characterized in, that the method further comprises providing the information of the preferred group of users to the network node (316).

27. Method according to claim 24, characterized in, that the social network is built from information of contacts between the users (1).

28. Method according to claim 27, characterized in, that the information of contacts between the users (1) is based on communication data comprising at least one of the following data: telephone calls, mobile messaging, e-mails, product recommendation messages, and instant messaging.

29. Method according to claim 24, characterized in, that determining the set of parameters comprises determining an innovator score for each user (306).

30. A method according to claim 29, characterized in, that the innovator score is calculated on the basis of user's data of purchase and usage history.

31. Method according to claim 24, characterized in, that determining the set of parameters comprises determining a repeat user score for each user (308).

32. Method according to claim 31, characterized in, that the repeat user score is calculated on the basis of user's data of purchase and usage history.

33. Method according to claim 24, characterized in, that determining the set of parameters comprises determining a social network influence score for each user (310).

34. Method according to claim 33, characterized in, that the social network influence score is calculated on the basis of user's data of contacts to other users, and their purchase history of certain products.

35. Method according to claim 24, characterized in, that said combining comprises defining an alpha user score for each user (1) based on combination of the social network and she set of parameters.

36. Method according to claim 35, characterized in, that the preferred group of users is defined on the basis of the alpha user score.

37. Method according to claim 36, characterized in, that the preferred group of users is a group of users (1) having the alpha user score higher than a predefined alpha user score limit.

38. Method according to claim 36, characterized in, that the preferred group of users is a predefined number of users (1) having highest alpha user score.

39. Method according to claim 36, characterized in, that the alpha user score limit and the number of users are predefined by the network node (2).

40. Method according to claim 25, characterized in, that the network node (2) wherefrom the request is received is one of the following: a telephone operator, an Internet. Service Provider (ISP), or an electronic store.

41. Method according to claim 24, characterized in, that the database (3) wherefrom the data is received is physically located in or operationally connected to one of the following: a server, a telephone operator, an Internet Service Provider (ISP), or an electronic store.

42. Method according to claim 24, characterized in, that the data is provided to the analyzer (9) from the database (3) through the network node (2).

43. Method according to claim 24, characterized in, that the data is provided to the analyzer (4) directly from the database (3).

44. Method according to claim 24, characterized in, that the data is provided to the analyzer (9) from a plurality of databases (3).

45. A computer-readable medium having stored thereon instructions for defining a preferred group of users, characterized in, that the instructions when executed by a processor cause the processor to:
receive user data from a database, wherein the user data comprises users' recommendations to other users;
determine a social network of the users based on the received user data;
determine a set of parameters far each user (1), said set of parameters including a parameter for a social network influence score; and
combine the social network and the set of parameters to define the preferred group of users.
